(19) United States
(12) Patent Application Publication
(10) Pub. No.: US 2009/0284859 A1
(43) Pub. Date: Nov. 19, 2009

(54) DATA STORAGE DEVICE HAVING DIFFERENT CONTROL INFORMATION IN DIFFERENT AREAS AND METHOD OF PROVIDING AND EMPLOYING THE SAME

(75) Inventors: Da-woon CHUNG, Suwon-si (KR); Dong-wook LEE, Hwaseong-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/434,104

(22) Filed: May 1, 2009

(30) Foreign Application Priority Data
May 14, 2008 (KR) 10-2008-0044718

(51) Int. Cl. G11B 20/10; G11B 5/82

(52) U.S. Cl. 360/39; 360/135; G9B/5.293; G9B/20.01

(57) ABSTRACT

A data storage device, such as a disk drive unit, includes at least one disk for storing data therein. The disk is divided into a plurality of tracks. The disk has at least a first set of tracks that each have stored therein at least one repeatable runout correction code for at least one area of the track, and a second set of tracks that each do not have stored therein any repeatable runout correction codes.

### PRIORITY STATEMENT

This application claims priority under 35 U.S.C. § 119 from Korean Patent Application 2008-0044718, filed on 14 May 2008 in the names of DaWoon Chung et al., the entirety of which is hereby incorporated by reference for all purposes as if fully set forth herein.

### SUMMARY

1. Field

This invention pertains to the data storage systems, such as disk drive units, and more particularly to a data storage device having different storage areas and different control information stored in the different areas.

2. Description

There continues to be a demand to process and store an ever-increasing amount and variety of digitized information. This demand is fueled in part by the desire to store and process digitized information from sources which generate a large volume of data, such as audio and video programming material. The demand for storing such large amounts of data in turn drives a desire for devices, including disk drive units, which can more efficiently store large amounts of data.

FIG. 1 shows a plan view of one embodiment of a data storage device, and specifically a disk drive unit 100. Disk drive unit 100 includes a spindle motor 14, a read/write head 16, an arm 20, a suspension 22, a magnet 28, a yoke 30, a pivot 32, and one or more disks 200 each having a plurality of tracks 210 formed thereon.

FIG. 2 illustrates a disk 200 of disk drive unit 100. Disk 200 includes a plurality of tracks 210 further divided into a plurality of sectors 220.

FIG. 3 illustrates the structure of sectors of a track 210 of disk 200. As shown in FIG. 3, servo sector (SS) 310 and data sectors (DS-i) 320 are consecutively positioned within disk 200 in a circular pattern from an inner ring to an outer ring of disk 200. As shown in FIG. 3, and described in greater detail below with respect to FIG. 4, servo sector 310 includes servo pattern (SS-1) 400 and Repeatable Run Out (RRO) Correction Code portion (SS-2) 450. Servo sectors 310 and data sectors 320 are employed during read/write operations for disk 200. In operation, disk drive unit 100 receives a read command or a write command from a host (e.g., a personal computer) for reading of writing specific data for disk drive unit 100, and disk drive unit 100 seeks an address of the target position of the requested data on disk 200. When disk drive unit 100 locates the target position, disk drive unit 100 reads from, or writes on, the data sector 320 by following the track 210 using servo sector 310.

FIG. 4 shows in more detail one example of servo pattern 400 of servo sector 220. Servo pattern 400 includes preamble 410, servo address mask (SAM) 420, grey code 430, burst 440 (e.g., an ABCD burst). Preamble 410 provides clock sync for reading of servo sector 320 and includes a gap before servo sector 320 to provide timing margin. SAM 420 identifies the start of servo sector 320. Gray code 430 identifies the track number. Burst 440 provides position signals for a read/write head of the disk drive unit to seek and follow the track 210.

In disk drive unit 100, repeatable runout is caused by the center of rotation being offset from the physical center of the disk (i.e., misalignment between the center of disk 200 and spindle motor 14 on which disk 200 is mounted), as well as disk wobble, etc. Repeatable runout causes a misalignment between read/write head 16 of the disk drive unit 100 and a track 210 that it is following on disk 200. Repeatable runout is the same for every revolution of disk 200. Accordingly, RRO Correction Code (RCC) portion 450 is written in servo sector 320 of disk 200 to correct the offset between read/write head 16 of disk drive unit 100 and track 210. RCC portions 450 are positioned after every servo sector 320 for correcting the head position when read/write head 16 performs a track seeking or track following operation.

In general there are areas or zones of disk 200 where the repeatable runout error is negligible, or at least small enough (e.g., less than some predetermined value) that correction is not required for the read/write head to properly follow the track 210. However, the RCC portion 450 is still recorded for these areas or zones, even though it is not needed.

So some of the RCC portions 450 are unused portions, and therefore wasted areas, of disk 200.

Accordingly, it would be desirable to provide a new data storage device, such as a disk drive unit, that corrects a repeatable runout error with a more efficient utilization of disk space. It would also be desirable to provide a new method of producing such a data storage device. It would further be desirable to provide a new method of correcting repeatable runout error in a data storage device.

In one aspect of the inventive concept, a disk drive unit comprises at least one disk for storing data therein, the disk being divided into a plurality of tracks, the disk having at least a first set of tracks that each have stored therein at least one repeatable runout correction code for at least one area of the track, and the disk having at least a second set of tracks that each do not have stored therein any repeatable runout correction codes.

In another aspect of the inventive concept, a method is provided for operating a disk drive unit having at least one disk for storing data therein, the disk being divided into a plurality of tracks. The method comprises: receiving at the disk drive unit a read/write command for the disk; determining a target area of the disk to which the read/write command pertains; determining whether a track in the target area of the disk has stored therein a repeatable runout correction code for at least one area of the track; adjust a servo control signal for accessing the track in the target area of the disk in response to whether the track has stored therein a repeatable runout correction code; and performing a read/write operation for the track in the target area of the disk using the adjusted servo control signal.

In yet another aspect of the inventive concept, a method is provided for arranging a data storage device. The method comprises providing at least one disk divided into a plurality of tracks, the disk having at least a first set of tracks that each have stored therein at least one repeatable runout correction code for at least one area of the track, and the disk having at least a second set of tracks that each do not have stored therein any repeatable runout correction codes.

In still another aspect of the inventive concept, a data storage device is divided into a plurality data storage areas, wherein a first set of data storage areas each includes a control information area storing therein information pertaining to the data storage area associated therewith, and wherein a second set of data storage areas each do not include the control information area.

In a further aspect of the inventive concept, a data storage device is divided into a plurality data storage areas, each data storage area having associated therewith a control information storage area pertaining to data stored therein, wherein a first set of control information areas each include a first field storing therein a first set of information pertaining to the data storage areas associated therewith, and wherein a second set of control information areas each include a second field storing therein a second set of information pertaining to the data storage areas associated therewith, wherein the first field is different than the second field.

In yet a further aspect of the inventive concept, a method is provided for operating a data storage device. The method comprises: receiving at the data storage device a read/write command for the data storage device; determining a target area of the data storage device to which the read/write command pertains; determining whether the target area of the data storage device has stored therein control information pertaining to the data storage areas associated therewith; and adjusting a read/write operation at the target area in response to whether the target area of the data storage device has stored therein the control information pertaining to the data storage area associated therewith.

In still a further aspect of the inventive concept, a method provides a data storage device divided into a plurality of data storage areas. The method comprises providing at least a first set of data storage areas each having stored therein a set of control information pertaining to the data storage area associated therewith, and further providing at least a second set of data storage areas each not having stored therein the set of control information.

### BRIEF DESCRIPTION OF THE DRAWINGS

FIG. 1 shows a plan view of one embodiment of a data storage device, and specifically a disk drive unit

FIG. 2 illustrates a disk of a disk drive unit.

FIG. 3 illustrates the structure of sectors of a track of a disk.

FIG. 4 shows one example of a servo pattern of a disk of a disk drive unit.

FIG. 5 illustrates portions of an exemplary data storage device.

FIG. 6A illustrates one embodiment of a portion of a track having a servo sector with a Repeatable Runout (RRO) Correction Code (RCC).

FIG. 6B illustrates one embodiment of a portion of a track having a servo sector which does not include an RCC.

FIG. 7 is a flowchart illustrating an embodiment of method of producing a data storage device.

FIG. 8 is a flowchart illustrating one embodiment of method of arranging a data storage device.

FIG. 9 is a flowchart illustrating one embodiment of method of reading data from a data storage device.

FIG. 10 illustrates signals according to one embodiment for accessing a track having a servo sector with an RCC portion.

FIG. 11 illustrates signals according to one embodiment for accessing a track that does not have an RCC portion.

FIG. 12 illustrates signals according to another embodiment for accessing a track that does not have an RCC portion.

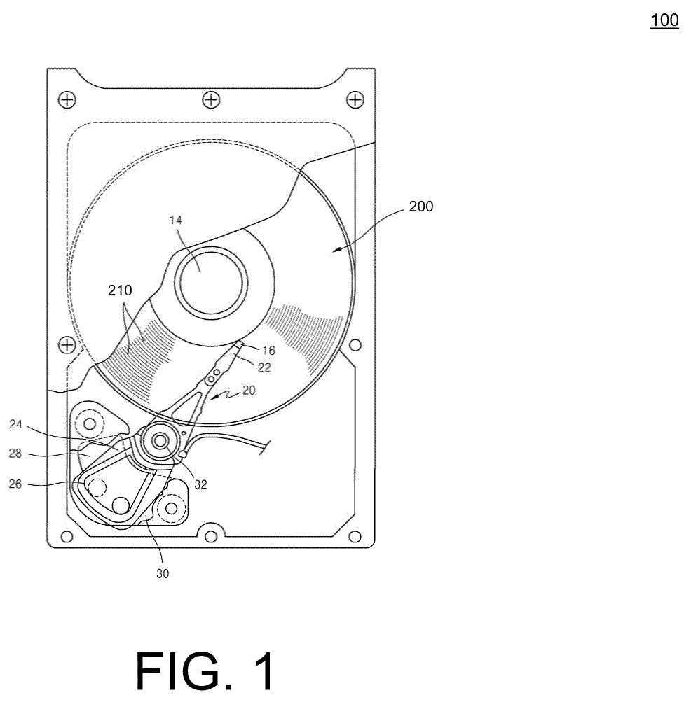

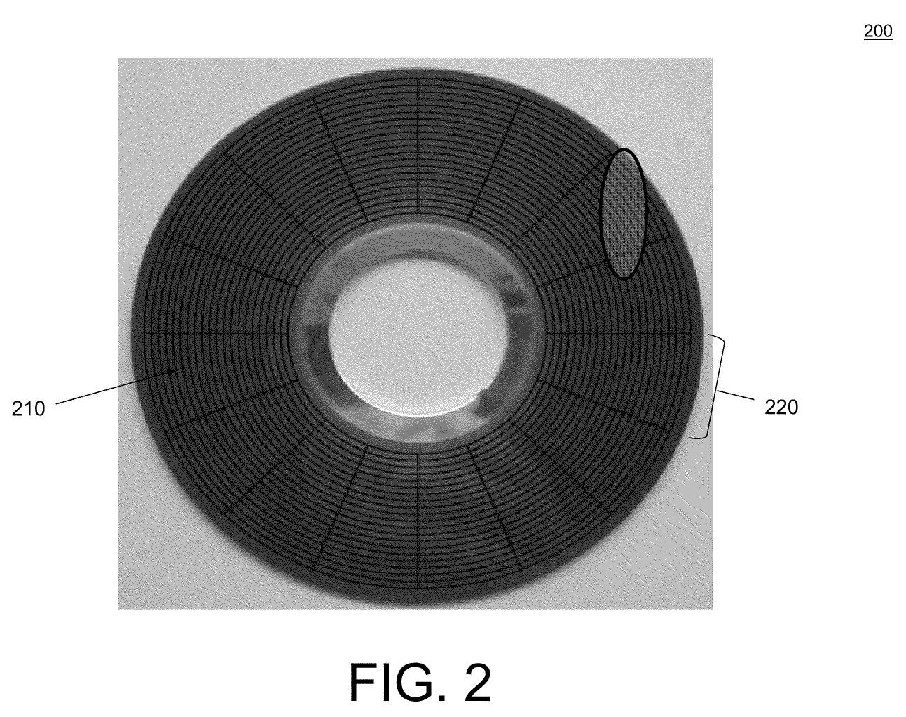

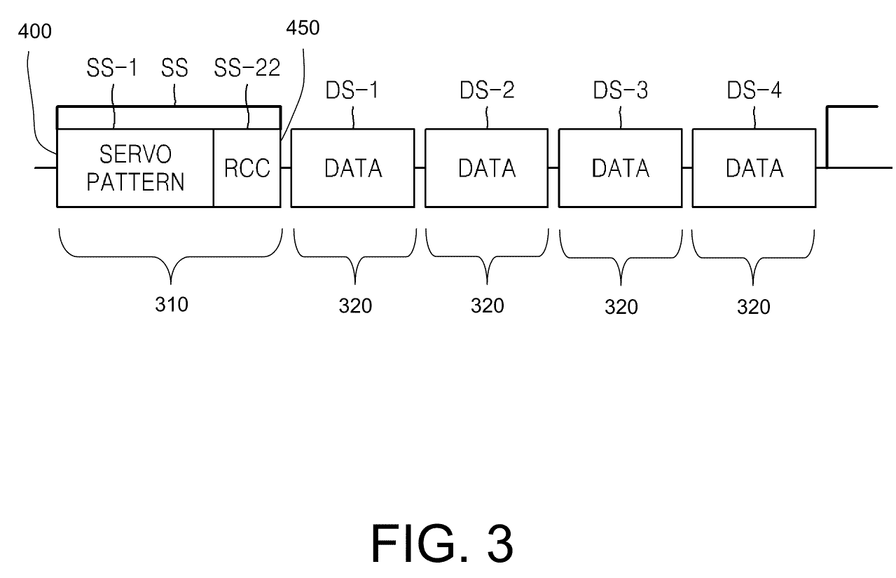

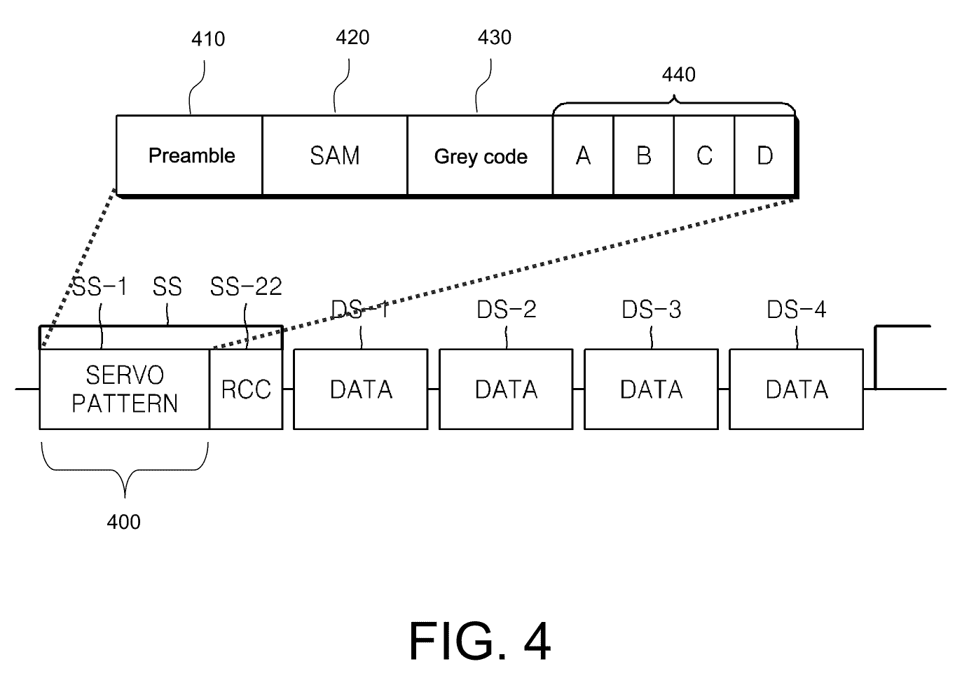

### DETAILED DESCRIPTION OF THE EMBODIMENTS

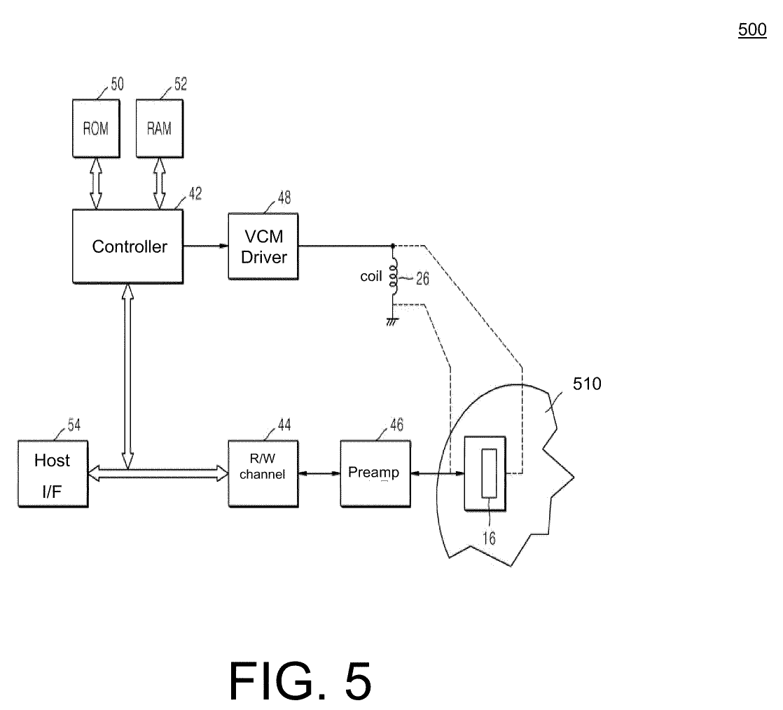

FIG. 5 illustrates an exemplary data storage device 500. Data storage device 500 includes a host interface 54, a hard disk controller (HDC) 42, a read/write channel 44, a pre-amplifier 46, one or more disks (e.g., hard disks) 510, a read head (or read/write head) 16, read only memory (ROM) 50, a random access memory (RAM) 52, a voice coil motor (VCM) 48, and a coil 26.

In one embodiment, each disk 510 of data storage device 500 has a plurality of tracks, including at least a first set of tracks that each have stored therein at least one Repeatable Runout (RRO) Correction Code (RCC) for at least one area of the track, and having at least a second set of tracks that each do not have stored therein any RCCs.

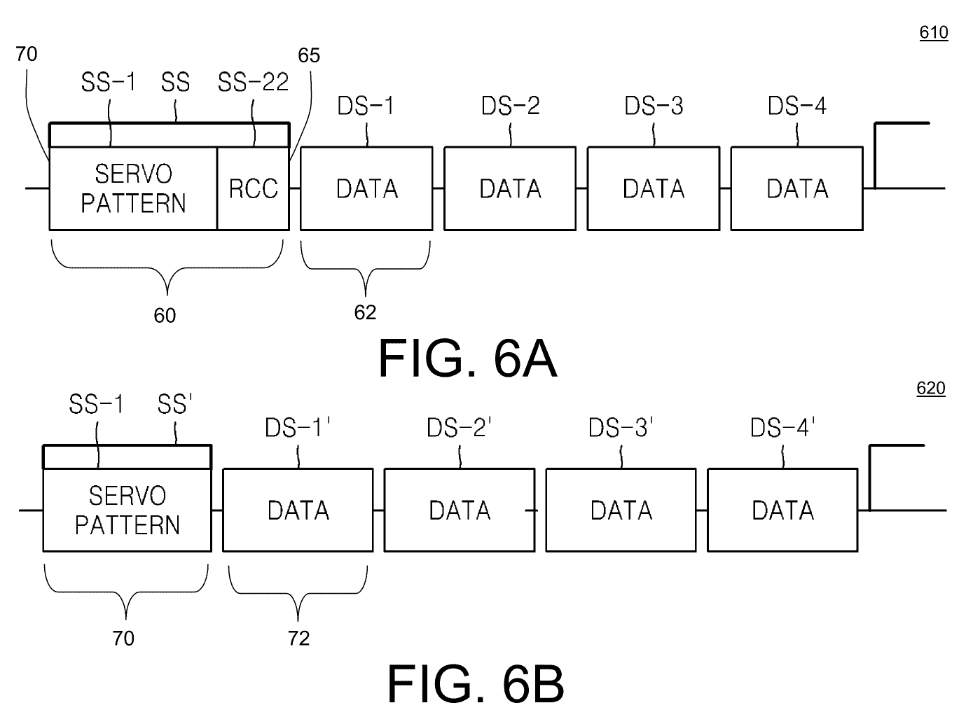

FIG. 6A illustrates one embodiment of a portion of a track 610 of disk 510 having a servo sector 60 with an RCC 65 and a servo pattern 70.

FIG. 6B illustrates one embodiment of a portion of a track 620 of disk 510 having a servo sector which includes servo pattern 70 but which does not include any RCC portion. Beneficially, because the RCC portion is eliminated from track 620 and therefore does not have to be read, the data transfer speed of track 620 can be increased. In the embodiment shown in FIG. 6B, the portion of track 620 which made available by elimination of the RCC portion is reallocated to create data sectors 72 that are lengthened compared to the data sectors 62 in track 610. In one embodiment, this means that the length of each bit of data in a data sector is increased. This can increase the data signal quality. In other embodiments, the portion of track 620 which is made available by elimination of the RCC portion can be used to add another data sector and thereby increase the data capacity of disk 510, or can contain another type of correction code or other function code for processing the corresponding data sector(s).

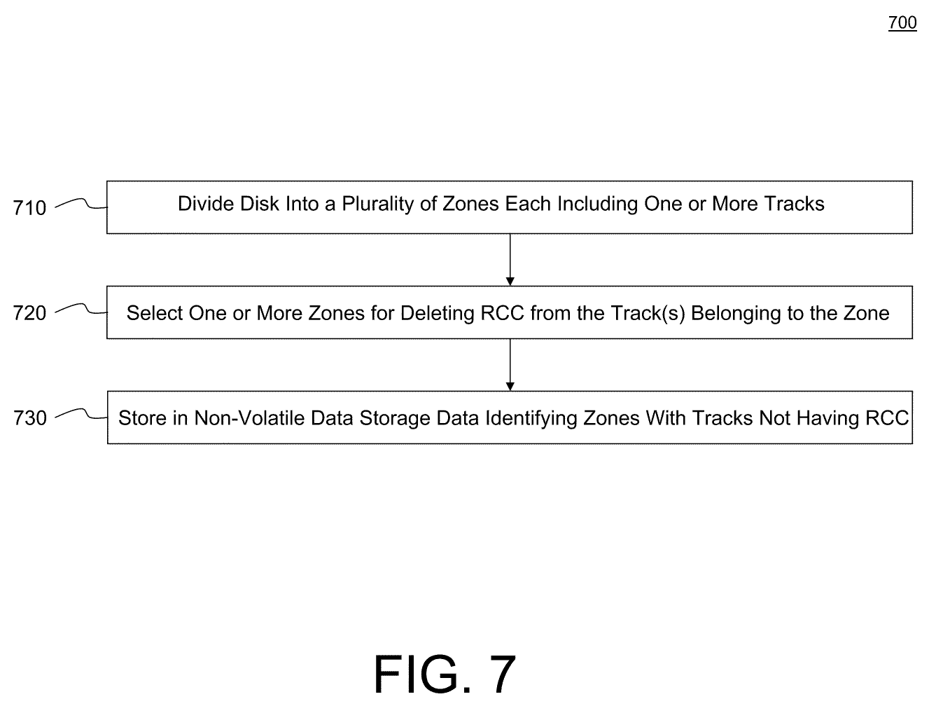

FIG. 7 is a flowchart illustrating an embodiment of method 700 of producing a data storage device (e.g., a disk in a disk drive unit). In a first step 710, a disk 510 is divided into a plurality of zones or groups, each of which includes one or more tracks. In a second step 720, one or more of the zones or groups are selected for deleting the Repeatable Runout (RRO) Correction Code (RCC) from the track(s) belonging to the zone or group. Accordingly, disk 510 includes a first set of tracks that each have stored therein at least one repeatable runout correction code (RCC) for at least one area of the track, and a second set of tracks that each do not have stored therein any RCCs. In a third step 730, information identifying which tracks of disk 510 belong to the second set of tracks is stored in a non-volatile data storage of the data storage device. Of course in an equivalent arrangement, information identifying which tracks of disk 510 belong to the first set of tracks may be stored in the non-volatile memory of the data storage device 500.

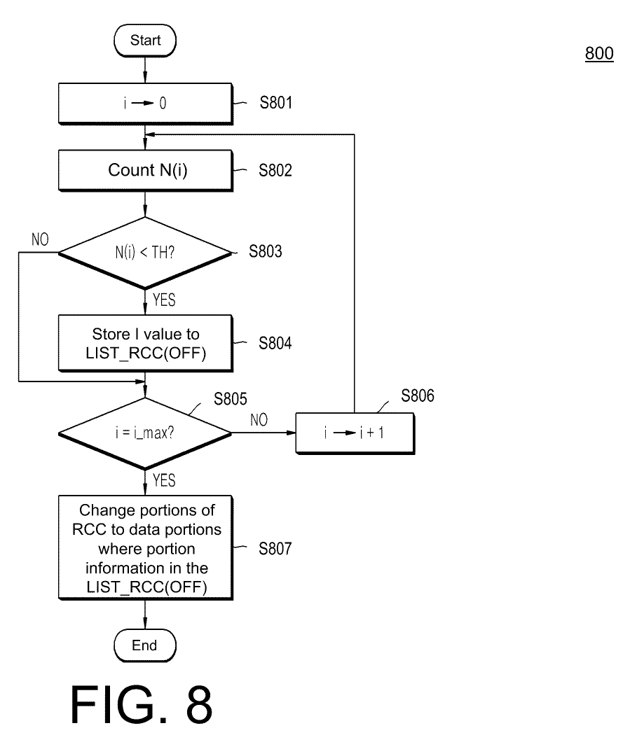

FIG. 8 is a flowchart illustrating an embodiment of method 800 of arranging a data storage device. In one embodiment, the method 800 may be performed by a processor in data storage device 500, for example a processor of controller 42.

In a step S801 a zone counter for disk 510 is initialized to 0. The zone counter may be included in controller 42. Disk 510 may be divided into areas or zones which, for example, may correspond to tracks, or a certain number of tracks (e.g., groups of 1000 tracks each) of disk 510. The zone counter counts through each zone or area of disk 510 as the method 800 is executed, as explained below.

In a step S802 the RCC information stored in the current zone i, is counted or added together to produce a value N(i). For example, in zone 0 (i=0), then the RCC information in zone 0 is counted to produce N(0).

In a step S803 N(i) is compared against a threshold value (TH). The threshold value TH is a value for which servo control for reading and writing to disk 510 is possible without using any RCC information. If N(i) is less than TH, then the process proceeds to step S804. Otherwise, the process proceeds to step S805.

In one embodiment, the TH value is predetermined by a test or a statistical measurement. In one illustrative example, each zone or area of disk 510 may include 1000 tracks and the threshold value TH may be set to 1% of the tracks in each zone (i.e., 10 tracks). In that case, in one embodiment if ten (10) or more of the tracks in zone i have the RCC values, then it is determined that RCC information should be stored in the tracks of zone i to maintain servo control for reading and writing to the tracks, and the process proceeds to step S805. Otherwise, if less than ten (10) tracks in zone i have the RCC values, then the process proceeds to step S804.

In step S804 the current counter value i—corresponding to a zone or area of disk 510 where it was determined in step S803 that N(i) value is less than the threshold value TH—is placed into a list LIST_RCC(OFF). The list LIST_RCC(OFF) identifies those zones or areas where the tracks will not have RCC values stored. The list LIST_RCC(OFF) may be stored in a register in controller 42, or in RAM 52, or in another convenient location in data storage device 500.

In step S805 the current counter value i is compared a maximum value i_max. Here, i_max corresponds to the last zone or area of the divided disk (i.e., the first zone of the divided disk 510 is i=0 and the last zone or area is i=i_max). If the counter value i is not equal to the maximum value i_max, then the process proceeds to step S806, where the counter value i is incremented by +1, and then the process returns to step S802. Otherwise, if the counter value i is equal to the maximum value i_max, then the process proceeds to step S807.

In step S807 the RCC portions of the servo sectors of the tracks in the zones or areas which are identified in the list LIST_RCC(OFF) are changed to other usage (e.g., changed to data storage areas). Also, in one embodiment, information identifying those tracks that do not have RCC values stored thereon is saved in an RCC table in data storage device 500. In one embodiment, the RCC table may comprise flags for all of the zones or areas of disk 510, and the flags are set to indicate that which of those zones or areas will not (or, in an alternative arrangement, will) include RCC values. In another embodiment, the RCC table may be a list of the zone numbers or area numbers of those zones or areas will not (or in an alternative arrangement, will) include RCC values. Other arrangements are possible. In some embodiments, the RCC table may be stored in a Maintenance Cylinder (MC) region of disk 510 or in non-volatile memory (e.g., ROM 50). As explained in greater detail below, during a data read/write operation, information from the RCC table is employed to determine whether a target track includes the RCC or not.

In an alternative embodiment, instead of creating RCC portions for all tracks, and then “converting” the RCC portions of those tracks that do not require the RCC for proper servo control to other uses, the process only creates the RCC portions for those tracks that do require the RCC for proper servo control after the determination is made in steps S801-S806 as to which tracks require the RCC. Again, other arrangements are possible.

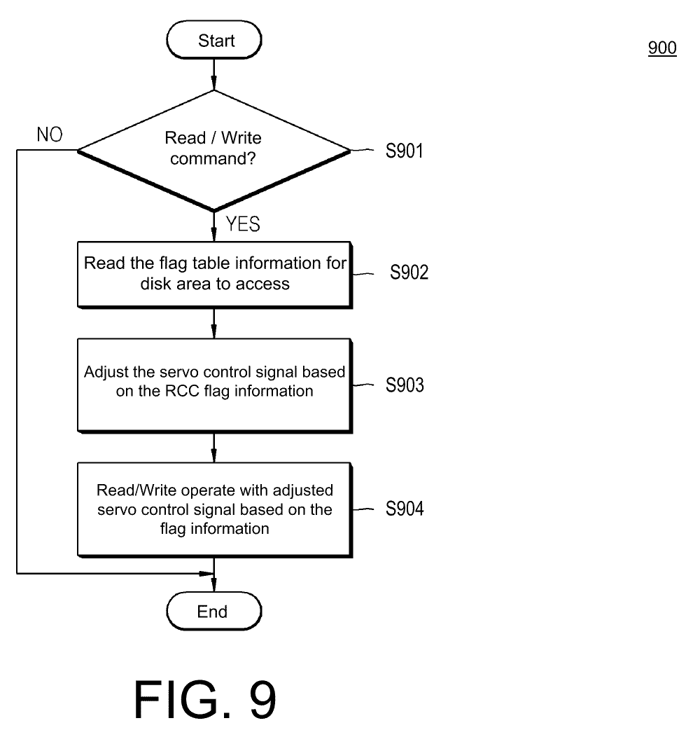

FIG. 9 is a flowchart illustrating one embodiment of method 900 of reading data from data storage device 500. In one embodiment, the method 900 may be performed by a processor in data storage device 500, for example a processor in controller 42. The process 900 starts, and then in a step S901 controller 42 determines whether data storage device 500 has received a read/write command. If not, then the process ends. If data storage device 500 has received a read/write command, then a target area of disk 510 to which the read/write command pertains is determined, and the process proceeds to step S902.

In step S902 it is determined whether a track in a target area or zone of disk 510 for the read/write command has stored therein a repeatable runout correction code (RCC) for at least one area of the track. As noted above with respect to FIG. 8, beneficially an RCC table may be stored in an appropriate location (e.g., a Maintenance Cylinder (MC) region of disk 510, or non-volatile memory (e.g., ROM 50)) in data storage device 500. In one embodiment, when power is first applied to data storage device 500 to initialize it, the RCC table stored in the MC region of disk 510 or in ROM 50 may be loaded into RAM 52 for further use in accessing disk 510. In that case, RCC information from the RCC table may be employed to determine whether a track in the target area or zone of disk 510 to be accessed has stored therein an RCC for at least one area of the track. In one embodiment, the RCC table may comprise flags for all of the zones or areas of disk 510, and the flags are set to indicate which of those zones or areas will not include RCC values. In that case, the RCC flag for the target zone or area is read from the RCC table and it is determined whether or not the target zone or area of disk 510 includes the RCC based upon whether of not the RCC flag is set. In another embodiment, the RCC table is a list of the zone numbers or area numbers of those zones or areas that do not include RCC values. In that case, the RCC table is checked to see whether or not the target zone or area is listed in the RCC table. Other arrangements are possible.

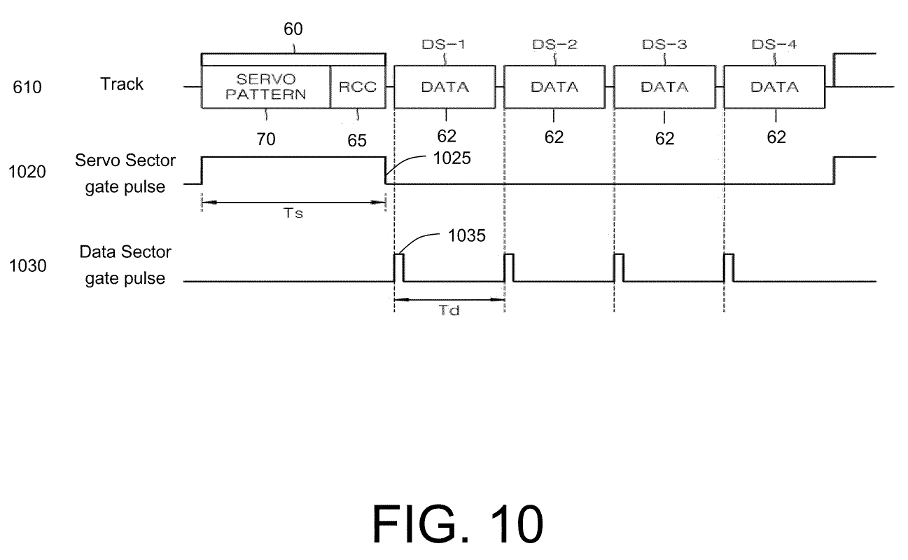

In a step S903 when a track seeking/following operation is performed for the read/write operation, then a servo control signal is adjusted based on the RCC information retrieved from the RCC table. The servo control signal is a control signal for generating a servo sector gate open/close signal and a data sector gate open/close signal, as will be explained in greater detail below with respect to FIGS. 10-12.

Then, in a step S904, a read/write operation is performed based on the servo control signal which is produced using the RCC information retrieved from the RCC table, and which in turn adjusts the timing of pulses for opening and closing the servo sector gate and the data sector gate, as will be explained in greater detail below with respect to FIGS. 10-12.

By employing methods such as those described above with respect to FIGS. 8 & 9, in the zones or areas of disk 510 where RCC value is less than a threshold value, the RCC portion 65 of the servo sector 60 can be changed to a data portion of data sector(s) 72 to thereby increase the data capacity or data density for disk 510, or to lengthen the size of each data bit for increased data quality, etc.

FIG. 10 illustrates signals according to one embodiment for accessing a track 610 having a servo sector 60 with an RCC 65. When data storage device 500 needs to access a track 610 of disk 510 that includes RCC 65 in the servo sector 60, it generates a servo control signal for the servo sector gate open/close timing and data sector gate open/close timing to read the servo sector 60 including servo pattern 70 and RCC 65. In particular, a servo gate signal 1020 is generated having a gate pulse 1025 whose length Ts is adjusted to read servo sector 60 which include servo pattern 70 and RCC 65. Also, a data gate signal 1030 is generated having data pulses 1035 each having a length Td to read data from a data sector 62.

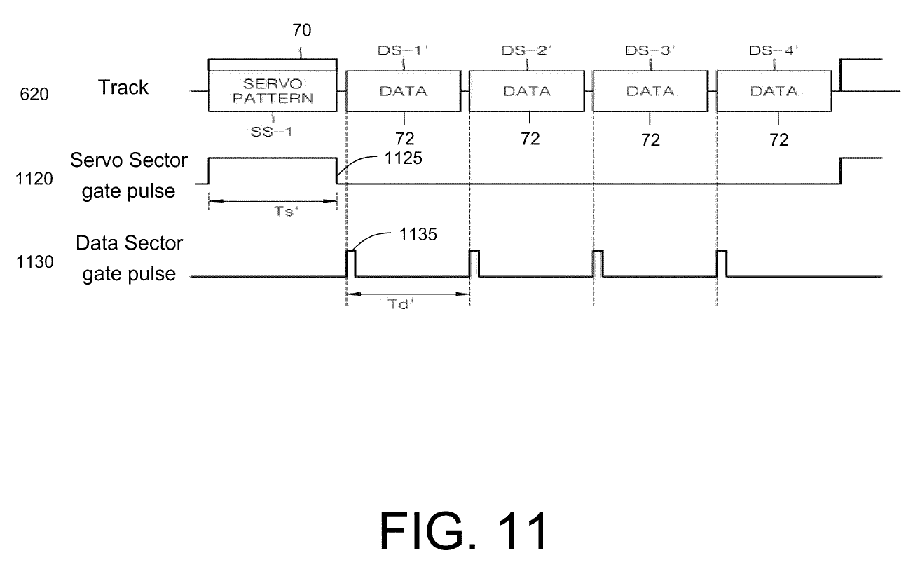

FIG. 11 illustrates signals according to one embodiment for accessing a track 620 having a servo sector which does not include an RCC 65. When data storage device 500 needs to access a track 620 of disk 510 that does not include any RCC 65 in the servo sector, it generates a servo control signal for the servo sector gate open/close timing and data sector gate open/close timing to read the servo sector. In particular, a servo gate signal 1120 is generated having a gate pulse 1125 whose length Ts' is adjusted to read servo pattern 70 and then to close. Also, a data gate signal 1130 is generated having data pulses 1135 each having a length Td′ to read data from a data sector 72.

Beneficially, Ts′<Ts and Td′>Td. In this case, the length of each data sector 72 is increased compared to the data sector 62 because the area of track 610 used for the RCC is changed to data storage area.

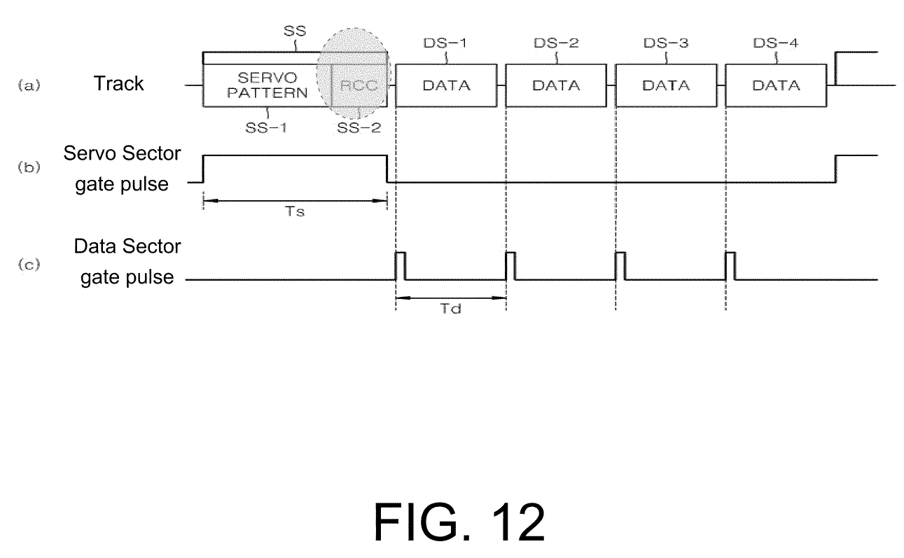

FIG. 12 illustrates signals according to another embodiment for accessing a track that does not have an RCC. In tracks of disk 510 that do not include the RCC, the RCC area can be used to store other values, codes, or data pertaining to the data sector(s) or used for data management. For example, the RCC portion may store compensation data, encryption data, security data, a function code, etc. for processing the “user” data in the data sectors of disk 510. In that case, the servo gate signal may be optionally opened or closed during the RCC portion by using the LIST_RCC(OFF) table stored in the data storage device.

The RCC portion is a physical area of disk 510 but that portion indicates as a logical portion for the system control data area in the logical data structure of disk 510, and that portion is using optionally in accordance with the RCC table which stores information which identifies where the RCC is used or not used in each area of disk 510.

Principles described above with respect to a disk drive unit can be generalized to other data storage devices.

For example, in one embodiment, a data storage device is divided into a plurality data storage areas, wherein a first set of data storage areas each includes a control information area storing therein information pertaining to the data storage area associated therewith, and wherein a second set of data storage areas each do not include the control information area. A method of operating such a data storage device includes receiving at the data storage device a read/write command for the data storage device; determining a target area of the data storage device to which the read/write command pertains; determining whether the target area of the data storage device has stored therein control information pertaining to the data storage areas associated therewith; and adjusting a read/write operation at the target area in response to whether the target area of the data storage device has stored therein the control information pertaining to the data storage area associated therewith.

In another example embodiment, a data storage device is divided into a plurality data storage areas, each data storage area having associated therewith a control information storage area pertaining to data stored therein, wherein a first set of control information areas each include a first field storing therein a first set of information pertaining to the data storage areas associated therewith, and wherein a second set of control information areas each include a second field storing therein a second set of information pertaining to the data storage areas associated therewith, wherein the first field is different than the second field.

While preferred embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

What is claimed is:

1. A disk drive unit comprising at least one disk for storing data therein, the disk being divided into a plurality of tracks, the disk having at least a first set of tracks that each have stored therein at least one repeatable runout correction code for at least one area of the track, and the disk having at least a second set of tracks that each do not have stored therein any repeatable runout correction codes.

2. The disk drive unit of claim 1, wherein each track includes a plurality of data sectors and a plurality of servo sectors, wherein each track of the first set of tracks has stored therein a repeatable runout correction code associated with each servo sector of the track.

3. The disk drive unit of claim 1, wherein when a track does not have stored therein any repeatable runout correction code, a length of the data sectors of such track is greater than when the track does have stored therein a repeatable runout correction code.

4. The disk drive unit of claim 3, wherein when a track does not have stored therein any repeatable runout correction code then a length of each bit of data of such track is greater than when the track does have stored therein a repeatable runout correction code.

5. The disk drive unit of claim 3, wherein when a track does not have stored therein any repeatable runout correction code then such track stores more bits of data than when the track does have stored therein a repeatable runout correction code

6. The disk drive unit of claim 1, wherein each track of the second set of tracks has stored therein a function code for processing data stored on the track.

7. The disk drive unit of claim 6, wherein the function code is one selected from the group of a compensation value, an encryption code, and a security code, for data in the data sectors of the track.

8. The disk drive unit of claim 1, further comprising a non-volatile memory storing therein information identifying which tracks of the disk belong to the second set of tracks.

9. The disk drive unit of claim 8, wherein the tracks are divided into a plurality of zones, and wherein the non-volatile memory has stored therein a runout correction code table having a plurality of runout correction code flags each corresponding to one of the plurality of zones, the runout correction code flag having a first value when tracks in the corresponding zone belong to the first set of tracks, and having a second value when tracks in the corresponding zone belong to the second set of tracks.

10. The disk drive unit of claim 8, wherein the tracks are divided into a plurality of zones, and wherein the non-volatile memory has stored therein a runout correction code table having a plurality of runout correction code flags, each flag indicating a corresponding zone of the disk where the tracks belong to the second set of tracks.

11. The disk drive unit of claim 8, further comprising a disk drive controller, wherein when the disk drive controller receives a read/write command for disk data, the disk drive controller accesses the non-volatile memory and adjusts a servo control signal in response to whether the disk data belongs to the first set of tracks or the second set of tracks, such that a length of a servo sector gate pulse is longer when the disk data belongs to the first set of tracks than when the disk data belongs to the second set of tracks.

12. A method of operating a disk drive unit having at least one disk for storing data therein, the disk being divided into a plurality of tracks, the method comprising:
receiving at the disk drive unit a read/write command for the disk;
determining a target area of the disk to which the read/write command pertains;
determining whether a track in the target area of the disk has stored therein a repeatable runout correction code for at least one area of the track;
adjust a servo control signal for accessing the track in the target area of the disk in response to whether the track has stored therein a repeatable runout correction code; and
performing a read/write operation for the track in the target area of the disk using the adjusted servo control signal.

13. The method of claim 12, wherein the step of determining whether the track in the target area of the disk has stored therein a repeatable runout correction code for at least one area of the track comprises reading from a runout correction code table stored in memory a runout correction code flag corresponding to the target area, the runout correction code flag having a first value when the track in the target area of the disk has stored therein a repeatable runout correction code for at least one area of the track and having a second value when the track in the target area of the disk does not have stored therein a repeatable runout correction code.

14. The method of claim 12, wherein the step of determining whether the track in the target area of the disk has stored therein a repeatable runout correction code for at least one area of the track comprises determining whether the target area is included in a runout correction code table stored in memory.

15. The method of claim 13, wherein the step of adjusting the servo control signal comprises making the length of a servo sector gate pulse longer when the track in the target area of the disk has stored therein a repeatable runout correction code for at least one area of the track, and making the length of a servo sector gate pulse shorter when the track in the target area of the disk does not have stored therein a repeatable runout correction code.

16. The method of claim 13, wherein performing the read/write operation for the track in the target area of the disk using the adjusted servo control signal comprises adjusting a period of a data sector gate in response to whether the track in the target area of the disk has stored therein a repeatable runout correction code.

17. The method of claim 16, further comprising making the length of a data sector gate pulse shorter when the track in the target area of the disk has stored therein a repeatable runout correction code for at least one area of the track, and making the length of a data sector gate pulse longer when the track in the target area of the disk does not have stored therein a repeatable runout correction code

18. The method of claim 13, further comprising reading a function code for processing data stored on the track in the target area of the disk when the track does not have stored therein a repeatable runout correction code.

19. The method of claim 16, the function code is one selected from the group of a compensation value, an encryption code, and a security code, for data in the data sectors of the track.

20. A method of arranging a data storage device, the method comprising providing at least one disk divided into a plurality of tracks, the disk having at least a first set of tracks that each have stored therein at least one repeatable runout correction code for at least one area of the track, and the disk having at least a second set of tracks that each do not have stored therein any repeatable runout correction codes.

21. The method of claim 20, further comprising storing in a non-volatile memory of the disk drive unit information identifying which tracks of the disk belong to the second set of tracks.

22. The method of claim 21, wherein providing the at least one disk divided into a plurality of tracks comprises defining a plurality of zones of the disk, each zone including a plurality of tracks, and wherein the non-volatile memory has stored therein a runout correction code table having a plurality of runout correction code flags, each flag indicating a corresponding zone of the disk where the tracks belong to the second set of tracks.

23. The method of claim 21, wherein providing the at least one disk divided into a plurality of tracks comprises defining a plurality of zones of the disk, each zone including a plurality of tracks, and wherein the non-volatile memory has stored therein a runout correction code table having a plurality of runout correction code flags each corresponding to one of the zones of the disk, the runout correction code flag having a first value when tracks in the corresponding zone belong to the first set of tracks, and having a second value when tracks in the corresponding zone belong to the second set of tracks

24. The method of claim 20, wherein providing the at least one disk comprises:
formatting the disk to have a plurality of servo sectors for each track;
writing on the disk a runout correction code corresponding to each servo sector;
defining a plurality of zones of the disk, each zone including a plurality of tracks; and
for each zone:
counting a number of tracks, N, where the runout correction code is nonzero;
comparing N to a threshold, and
when N is less than the threshold, then storing a flag in non-volatile memory indicating that the tracks in the zone belong to the second set of tracks, and changing areas in the zone where the runout correction code is stored to no longer be runout correction code areas.

25. The method of claim 24, wherein changing areas in the zone where the runout correction code is stored to no longer be runout correction code areas comprises changing the areas to be data areas.

26. The method of claim 24, wherein changing areas in the zone where the runout correction code is stored to no longer be runout correction code areas comprises changing the areas to be function code areas.

27. A data storage device divided into a plurality data storage areas, wherein a first set of data storage areas each includes a control information area storing therein information pertaining to the data storage area associated therewith, and wherein a second set of data storage areas each do not include the control information area.

28. A data storage device divided into a plurality data storage areas, each data storage area having associated therewith a control information storage area pertaining to data stored therein, wherein a first set of control information areas each include a first field storing therein a first set of information pertaining to the data storage areas associated therewith, and wherein a second set of control information areas each include a second field storing therein a second set of information pertaining to the data storage areas associated therewith, wherein the first field is different than the second field.

29. A method of operating a data storage device, the method comprising:
receiving at the data storage device a read/write command for the data storage device;
determining a target area of the data storage device to which the read/write command pertains;
determining whether the target area of the data storage device has stored therein control information pertaining to the data storage areas associated therewith; and
adjusting a read/write operation at the target area in response to whether the target area of the data storage device has stored therein the control information pertaining to the data storage area associated therewith.

30. A method of providing a data storage device divided into a plurality of data storage areas, the method comprising providing at least a first set of data storage areas each having stored therein a set of control information pertaining to the data storage area associated therewith, and further providing at least a second set of data storage areas each not having stored therein the set of control information.
